(19) United States
(12) Patent Application Publication
(10) Pub. No.: US 2014/0263390 A1
(43) Pub. Date: Sep. 18, 2014

(54) Pack Dispenser

(71) Applicant: Robert W. Seneff, Pewaukee, WI (US)

(72) Inventor: Robert W. Seneff, Pewaukee, WI (US)

(21) Appl. No.: 14/206,660

(22) Filed: Mar. 12, 2014

Related U.S. Application Data
(60) Provisional application No. 61/790,165, filed on Mar. 15, 2013.

(51) Int. Cl. G07F 9/02

(52) U.S. Cl. CPC G07F 9/026
USPC 221/7

(57) ABSTRACT

A pack dispenser system including a housing including a holding assembly for holding a pack that is manually removable from the holding assembly. A tamper resistant sensor is associated with the holding assembly and is operable to actuate when the pack is removed from the dispenser system. A controller is associated with the tamper resistant sensor and is operable to record a removed item count to a memory each time a pack is removed from the holding assembly.

### RELATED APPLICATIONS

This application claims the benefit of U.S. Provisional Patent Application No. 61/790,165 filed on Mar. 15, 2013, the entire disclosure of which is hereby incorporated herein by reference.

### BACKGROUND

The invention is directed to a system for dispensing retail items. In particular, the invention is directed to dispensing packs and cartons of cigarettes in a retail or convenience store setting.

Cigarettes have a high retail value. Cigarette theft is a significant problem in the retail setting. Cigarette theft lowers profits for a retail establishment. Existing systems for counting and tracking cigarettes often include a large amount of manual counting and indirectly affect profit via wasted labor cost.

Many stores use methods of counting cigarette packs and cartons after each work shift to arrive at a pack count. The pack count is subsequently compared to a shift report that totals the number of cigarette packs and cartons sold. Existing methods are labor intensive and unreliable. Even with a good system it is hard to verify down to a single cigarette pack.

By way of example, if a retail establishment manually counts cigarette packs and cartons during each shift (3) for an average of 20 minutes, labor expenses can easily amount to more than $5,000 per year at current retail employee wage rates. If the retail establishment loses one cigarette pack a day at a cost of $6.50 per cigarette pack the loss would accumulate to $2,400 per year. Combined with the labor expense the retail establishment may easily be losing $7,400 per year.

While cigarettes present a significant loss concern, other retail items also suffer from theft and necessary monitoring in an attempt to prevent theft.

### BRIEF SUMMARY OF THE INVENTION

In one embodiment, the invention provides a pack dispenser system including a housing including a holding assembly for holding a pack that is manually removable from the holding assembly. A tamper resistant sensor is associated with the holding assembly and is operable to actuate when the pack is removed from the dispenser system. A controller is associated with the tamper resistant sensor and is operable to record a removed item count to a memory each time a pack is removed from the holding assembly.

In another embodiment, the invention provides a method of operating a pack dispenser system. The method includes manually removing a pack from the pack dispenser system, recording a removed item count to a memory in response to removing the pack from the pack dispenser system, selling the pack after manually removing, recording a sale record in response to selling the pack, and comparing the removed item count to the sale record.

In another embodiment, the invention provides a method of selling product packs. The method includes employing a human operator to dispense the packs from a secure system that includes a housing that defines a plurality of columns of packs. The pack at the bottom of each column being supported on a slide carriage of the column that is operable manually by the human operator to slide the bottom pack forward to an opening through which the human operator can remove the bottom pack from the housing, a plurality of sensors that detect when the bottom pack of each column has been removed from the housing, a control unit connected to the sensors that count how many packs have been removed from the housing, and a video surveillance system focused on the housing. The human operator refills the housing with packs, and the control unit turns on the video surveillance system when the housing is opened.

### BRIEF DESCRIPTION OF DRAWINGS

The invention will be better understood and features, aspects and advantages other than those set forth above will become apparent when consideration is given to the following detailed description. Such detailed description makes reference to the following drawings.

FIG. 1 is a top perspective view of a dispenser system.

FIG. 2 is a bottom perspective view of the dispenser system of FIG. 1.

FIG. 3 is a front view of the dispenser system of FIG. 1.

FIG. 4 is a bottom view of the dispenser system of FIG. 1.

FIG. 5 is a back view of the dispenser system of FIG. 1.

FIG. 6 is a perspective view of a plurality of holding assemblies of the dispenser system of FIG. 1.

FIG. 7 is a perspective view of a holding assembly of FIG. 6 in a first position.

FIG. 8 is a perspective view of the holding assembly of FIG. 7 in a second position.

FIG. 9 is a perspective view of the holding assembly of FIG. 7 in a third position.

FIG. 10 is a side view of the holding assembly of FIG. 7 in the first position.

FIG. 11 is a side view of the holding assembly of FIG. 7 in the second position.

FIG. 12 is a side view of the holding assembly of FIG. 7 in the third position.

FIG. 13 is a detail view of the holding assembly of FIG. 7 in the first position.

FIG. 14 is a detail view of the holding assembly of FIG. 7 in the second position.

FIG. 15 is a detail view of the holding assembly of FIG. 7 in the third position.

FIG. 16 is an exploded top perspective view of a slide assembly of the holding assembly of FIG. 7.

FIG. 17 is an exploded bottom perspective view of the slide assembly of FIG. 16.

FIG. 18 is a side view of the dispenser system of FIG. 1 in an open position.

FIG. 19 is a perspective view of another dispenser system.

FIG. 20 is a detailed view of the dispenser system of FIG. 19.

FIG. 21 is a schematic view of an electrical system of the dispenser system of FIG. 1.

FIG. 22 is a flow chart representing the operation of the dispenser system of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

FIGS. 1-5 show a dispenser system 10 for holding, dispensing, and counting individual cigarette packs 14. In other embodiments, the dispenser system 10 may be used with other packs or items than cigarette packs. For example, the invention may be applied to other tobacco products (e.g., chewing tobacco, snus, snuff), alcohol products, or any other items that may need to be carefully tracked. The invention may be used for any pack or item in a retail setting.

The dispenser system 10 includes a frame 18 configured to be mounted above a retail counter (not shown), a control box 22 and a holding system 26 mounted to the frame 18. The control box 22 includes an upper portion 30 that houses a controller 34 (see FIG. 21) and a display in the form of an LCD display 38, and a lower portion 42 that houses a keypad 46, a USB port 50, and a discarded pack bin 54.

The upper portion 30 is selectively closed by an upper locking door 58 and the lower portion 42 is selectively closed by a lower locking door 62. The upper locking door 58 is fastened in place (e.g., with screws) and is typically not opened during normal operation of the dispenser system 10. The lower locking door 62 is opened in response to an authorized code entered into the keypad 46. The USB port 50 and the discarded pack bin 54 are positioned within the lower portion 42 and secured behind the lower locking door 62. A USB device 66 is received in the USB port 50 to record data as will be described in detail below.

The lower locking door 62 defines a discarded pack opening 72 which provides access to the discarded pack bin 54. A discarded pack sensor 76 is arranged to recognize any cigarette pack 14 that is dropped through the discarded pack opening 72 into the discarded pack bin 54. When the lower locking door 62 is closed and locked, access to the discarded pack bin 54 is inhibited.

The holding system 26 includes a front door 82 movable between an open position and a closed position, a swinging front holder row 86 movable between a swung open position and a closed position, and a stationary rear holder row 90. The front door 82, the front holder row 86 and the rear holder row 90 are coupled together by a closing linkage 94. The linkage 94 maintains the dispenser system 10 in an open position (see FIG. 18) wherein the front door 82 is open and the swinging front holder row 86 is in the swung open position. In the open position, a user is provided with access to the front holder row 86 and the rear holder row 90. The linkage 94 is lockable with a physical tumbler style key or the controller 34. For example, the front door 82 may be opened in response to an authorized code entered into the keypad 46.

Turning to FIG. 6, each of the front holder row 86 and the rear holder row 90 are made up of fourteen pack holding assemblies 98. The holding assemblies 98 arranged in the front holder row 86 are the same as the holding assemblies 98 arranged in the rear holder row 90. A single holding assembly 98 will be discussed below. While the illustrated embodiment includes fourteen holding assemblies 98 per row, any number of holding assemblies 98 may be arranged in a row (e.g., 10, 20, 40, or more). Further, only a single row or more than two rows are possible.

FIG. 5 shows a rear wall 99 mounted on a rear face of the front holder row 86 and the rear holder row 90. Each rear wall 99 includes a plurality of block apertures 100, each aligned with an associated holding assembly 98. The block apertures 100 are sized such that a pack 14 cannot pass therethrough.

With reference to FIG. 7, the holding assembly 98 includes a mounting rail 102, a partition wall 106 fixed to the mounting rail 102, a base plate 110 coupled to the partition wall 106 and the mounting rail 102, a sliding carriage 114 slidably engaged with the base plate 110 and movable between a first or retracted position (see FIG. 7) and a second or extended position (see FIG. 9), and a guard member 118 rotatably coupled to the sliding carriage 114 and movable between a first or closed position (see FIG. 7) and a second or open position (see FIG. 9).

A sensor in the form of a limit switch 122 is coupled to the partition wall 106 and arranged to be actuated between a set state and an actuated state when the pack of cigarettes 14 is removed. The limit switch 122 includes an actuator in the form of a lever 124 (clearly visible in FIG. 12) that is arranged to engage the sliding carriage 114 and actuate from the set state to the actuated state when the sliding carriage 114 is moved forward and clears the lever 124. The sensor could be another sensor type (e.g., a hall effect sensor, et cetera) or be arranged differently with respect to the holding assembly 98 so long as the sensor can be actuated accurately each time a new pack 14 is removed. Additionally, the sensor may be a normally open switch or a normally closed switch and wired accordingly to provide a count that represents the number of packs 14 removed from the dispenser system 10.

The mounting rail 102 of each holding assembly 98 is configured to attach to an adjacent mounting rail 102 to form the front holder row 86 and the rear holder row 90 respectively (see FIG. 6). The partition walls 106 cooperate to partition the separate holder assemblies 98 from one another such that cigarette packs 14 in one holder assembly 98 are isolated from other holder assemblies 98. In a typical installation, each holder assembly 98 will hold a different cigarette brand.

FIGS. 16 and 17 show detailed views of the base plate 110 and the sliding carriage 114. The base plate 110 includes mounting features in the form of apertures 126 sized to receive fasteners for attachment to the mounting rails 102. Other mounting features may be utilized to couple the base plate 110 to the mounting rails 102, as desired. The base plate 110 further defines a slide aperture 130 and depressed ramps 134.

The sliding carriage 114 includes a handle 138 extending from a bottom surface of the sliding carriage 114 and sized to be received through the slide aperture 130 of the base plate 110. The cooperation of the handle 138 and the slide aperture 130 defines a path of movement for the sliding carriage 114 between the retracted position and the extended position. Additionally, the cooperation of the handle 138 and the slide aperture 130 defines the range of motion of the sliding carriage 114.

The sliding carriage 114 further includes a block 142, a back stop 146, a floor 150, a guard mounting feature in the form of two guard apertures 154 (only one visible in FIGS. 16 and 17), and guard projections 158. The block 142 is sized to pass through the block aperture 100 formed in the rear wall 99. In other words, the block 142 is narrower than the pack 14 such that it may pass through the block aperture 100.

Turning to FIG. 21, the dispenser system 10 includes an electrical system 162 that includes the controller 34, the display 38, the key pad 46, the USB port 50, the discarded pack sensor 76, and the limit switches 122. The electrical system 162 further includes a power supply 166 providing power to the electrical system 162, a lower locking door sensor 174 associated with the lower locking door 62, a front door sensor 178 associated with the front door 82, a surveillance system 182 which may be the same surveillance system used in the retail establishment, and an alarm 186. The controller 34 communicates with and coordinates all the components of the electrical system 162 as will be discussed below. In other embodiments, the electrical system 162 may include an additional door sensor arranged to monitor the upper locking door 58 in case of a forced break in.

Operation of the dispenser system 10 will be discussed with respect to FIG. 22. At the start of a shift (at 200), a manager or other authorized person enters the authorized keycode into the keypad 46 and is authorized by the controller 34 (at 204). The controller 34 then records a time stamp of the event to a memory 190 (at 206). The time stamp will note the date/time the dispenser system 10 was accessed (e.g., “Sep. 17, 2012 04:42:05 pm—access code entered”).

The lower locking door 62 and the front door 82 are then unlocked by the controller 34 and the authorized person moves the front door 82, the lower locking door 62, and the front holder row 86 of the dispenser system 10 to the open position. The linkage 94 then maintains the dispenser system 10 in the open position (at 208).

When the dispenser system 10 is unlocked (e.g., by entering an authorized keycode), the controller 34 activates the surveillance system 182, the alarm 186, and writes a time stamp to the memory 190 with a note about the event (e.g., “Door opened”) (at 212). The surveillance system 182 records a video of the dispenser system 10 area and an owner or other user may review the tape to watch what happens while the dispenser system 10 is open. The alarm 186 sounds such that employees know the dispenser system 10 is unlocked and that the surveillance system 182 is operating. The time stamp will record the event type, the date, and the time. The time stamp allows the owner to reference specific times during the video recording that correspond with individual events (e.g., only when the dispenser system 10 is open).

With the dispenser system 10 open, and the surveillance system 182 and alarm 186 operating, the employee (typically a retail store clerk) loads cigarette packs 14 into the holder rows 86, 90 (at 216). The employee then closes the dispenser system 10 (at 220) at which point the surveillance system 182 and alarm 186 are deactivated and a time stamp is recorded to the memory 190 (at 224).

After loading, normal operation occurs during the shift. When a customer would like a pack of cigarettes 14, the employee grasps the handle 138 and pulls the sliding carriage 114 toward the extended position. FIGS. 7-15 show the action of moving the sliding carriage 114 between the retracted and extended positions. The employee pulls on the handle 138 and as the sliding carriage 114 extends from the base plate 110, the guard member 118 drops along the ramps 134 and out of engagement with the pack of cigarettes 14. When the sliding carriage 114 leaves the retracted position, the limit switch 122 changes state from the set state to the actuated state. In other words the lever 124 swings to an actuated position. At that point a count is sent from the limit switch 122 to the controller 34 and the memory 190 (at 232).

As the sliding carriage 114 reaches the extended position, the guard member 118 moves to the open position. The backstop 146 of the sliding carriage 114 pushes the pack 14 as the sliding carriage 114 is pulled toward the extended position. Only when the sliding carriage 114 is fully extended is the guard member 118 fully opened (or lowered), to permit the employee to pull the pack of cigarettes 14 from the dispenser system 10 and give them to the customer (at 228). Also note that guard member 18 moves back up to block the slot through which packs 14 are removed before the carriage 114 is moved back far enough toward the retracted position to re-set the switch 122.

While the bottom pack of cigarettes 14 is being removed from the dispenser system 10, the column of packs 14 above the bottom pack 14 is held up above the carriage 114 by a top surface of the bottom pack 14. When a rear edge of the bottom pack 14 moves past a front edge of the next pack 14 in the column, the column of packs 14 will then be supported by the block 142. The next pack 14 is inhibited from being removed from the dispenser system 10 by the block 142. The next pack 14 may only fall onto the floor 150 of the sliding carriage 114 when the sliding carriage 114 is moved fully into the retracted position after the bottom pack 14 has been removed, and after the block 142 has been moved back through the block aperture 100.

When the sliding carriage 114 is moved back into the retracted position, with the block 142 extending through the block aperture 100, the next pack 14 falls to the floor 150 and the limit switch 122 is re-set by the sliding carriage 114 interacting with the lever 124. This provides a cumulative count that is representative of how many packs 14 have been removed from the dispenser system 10. Under normal circumstances, the dispenser system 10 will continue to function with the employee removing packs 14 for customers and each pack being counted.

If the employee should remove an incorrect pack 14, such that the customer does not wish to buy the pack 14, the employee deposits the pack 14 (at 240) in the discarded pack bin 54 through the discarded pack opening 72. The discarded pack sensor 76 will then deduct a count (at 244) from the memory 190 such that the cumulative count of packs remains correct. Alternatively, discarded packs 14 may be counted separately such that the count of discarded packs is cumulative and representative of how many packs 14 are discarded into the discarded pack bin 54 during any given shift.

Before an end of the shift, the authorized person will again enter the authorized keycode into the keypad 46 and is authorized by the controller 34 (at 248). The controller 34 then records a time stamp of the event to the memory 190 (at 252).

The lower locking door 62 and the front door 82 are then unlocked by the controller 34 and the authorized person moves the front door 82, the lower locking door 62, and the front holder row 86 of the dispenser system 10 to the open position. The linkage 94 then maintains the dispenser system 10 in the open position (at 256). Any time the dispenser system 10 or any component thereof is opened (i.e., access to any component is possible), the surveillance system 182 and alarm 186 are activated and a time stamp is recorded to the memory 190 (at 258).

The authorized person then manually counts the discarded packs 14 (at 260) in the discarded pack bin 54, restocks the holding assemblies 98 as needed (at 264), removes the USB device 66 or otherwise exports a report of the count of removed packs, discarded packs, and time stamps (at 268), and closes the dispenser system 10 (at 272). The alarm 186 and surveillance system 182 are then turned off and a time stamp is recorded to the memory 190 (at 274).

The report is then compared (at 278) to data retrieved from a register 280. Ideally, the data on the register 280 shows that the number of packs 14 sold equals the count of packs 14 removed minus the count of discarded packs 14 in the discarded pack bin 54. In addition, a full computer type display could be provided connected to the controller 34 to visualize a real time inventory/count.

If the report matches the register data, then all is well and no packs 14 are unaccounted for. The shift is then ended (at 282). If, however, the register data does not match the report, then the authorized user can access the time stamps to determine when a pack 14 may have been stolen. The time stamps will provide the time/date and description of any event that occurred during that shift.

For example, a time stamp may be recorded to the memory 190 every time any of the following events occur: a loss of power from the power supply 166, the controller 34 loses power, the controller 34 regains power, any of the doors 62, 82 are opened, the USB device 66 is inserted, the USB device 66 is removed, any keycode is entered, and/or the time/date are set or altered. Other system vulnerable events may be important as well and a time stamp may be recorded as desired, and the surveillance system 182 turned on during the vulnerable events. The following is one example of the time stamp data that may be stored on the USB device 66:

Sep. 17, 2012 03:56:00 PM—Power lost

Sep. 17, 2012 03:56:11 PM—Power restored

Sep. 17, 2012 04:34:01 PM—Access code entered

Sep. 17, 2012 04:34:27 PM—Door opened

Sep. 17, 2012 04:34:30 PM—USB flash drive removed

Sep. 17, 2012 04:34:42 PM—USB flash drive connected

Sep. 17, 2012 04:39:59 PM—Door closed

Sep. 17, 2012 04:39.40 PM—Access code entered

Sep. 17, 2012 04:40:04 PM—Door opened

Sep. 17, 2012 04:40:08 PM—Door closed

Sep. 17, 2012 04:40:13 PM—Door opened

Sep. 17, 2012 04:40:17 PM—Door closed

Sep. 17, 2012 04:42:00 PM—Power lost

Sep. 17, 2012 04:42:04 PM—Power restored

Sep. 17, 2012 04:41:30 PM—USB flash drive removed

Sep. 17, 2012 04:42:05 PM—USB flash drive connected

Sep. 17, 2012 04:42:13 PM—Door opened

Sep. 17, 2012 04:42:15 PM—Door closed

Sep. 17, 2012 04:42:23 PM—Door opened

Sep. 17, 2012 04:42:45 PM—Door closed

The authorized user may then review the time stamps to determine when a possible theft may have occurred. A review of the surveillance recording during the time indicated on the suspect time stamp will provide the authorized user with a video recording of what was happening during the time stamped event. This will answer for the authorized user what happened to the unaccounted for pack 14.

The above description detailed how the dispenser system 10 works for one holding assembly 98. In a system 10 such as that illustrated in FIG. 1, there are twenty-eight holding assemblies 98. The controller 34 is in communication with each limit switch 122 and registers a count with each pack 14 removed regardless of the specific holding assembly 98 it was removed from. At the end of the shift, the authorized user then compares the count of each pack 14 removed from the dispenser system 10 to the total number of pack 14 sold through the register.

In other embodiments, each brand of cigarette may be tracked and have a count saved in the memory 190 associated with how many packs 14 of each brand have been removed. At the end of the shift, the authorized user can then compare the count of each pack 14 of a particular brand removed to the corresponding number of packs 14 of that brand sold through the register 280. This may provide a more specific tracking of each pack 14 sold or removed.

Tracking the total number of packs 14 removed provides a simple and fast method for tracking packs. If one pack 14 is unaccounted for, a comparison with the register data will alert the authorized user to the missing pack 14. The authorized user can then check through the time stamps.

Counting each individual brand provides an alternative way to track packs 14. For example, the report may indicate that twelve packs 14 of brand A were removed and three packs 14 of brand B were removed. The authorized user can then check the register 280 to see how many sales of brand A and brand B were sold. If twelve packs 14 of brand A and three packs 14 of brand B were sold through the register 280, all is well. Of course, the authorized user will also still need to check the discarded pack bin 54. For example, if the same twelve packs 14 of brand A were removed, but the register 280 shows that only ten packs 14 of brand A were sold, there is a two pack 14 discrepancy. If the authorized user then finds two packs 14 of brand A in the discarded pack bin 54, all packs are accounted for. If, however, no packs 14 of brand A are found in the discarded pack bin 54, then the authorized user knows that two packs 14 of brand A are unaccounted for. The authorized user would then review the time stamps on the report to aid in discovery of what happened to the unaccounted for packs 14, and if necessary the surveillance system 182.

The holding assemblies 98 are configured such that a thief cannot remove a pack 14 without actuating the limit switch 122. In other words, the system for counting the number of packs 14 removed from the dispenser system 10 is tamper-proof. The pack of cigarettes 14 can only be removed when the sliding carriage 114 is fully extended and the next pack 14 can only fall into place when the sliding carriage 114 is fully in the retracted position after counting a removed pack 14. The guard member 118 blocks packs 14 from being removed when the sliding carriage 114 is in the retracted position.

The door sensors 174, 178 may actively switch on the surveillance system 182 either through the controller 34 or directly (i.e., independent of the controller 34). Regardless of specific arrangement, the inventive system activates the surveillance system 182 when access to the cigarette packs 14 is provided. In one embodiment, the surveillance system 182 is a video camera with an attached digital video recorder (DVR).

The linkage assembly 94 inhibits the front holder row 86 from swinging away from the rear holder row 90 unless the front door 82 is open.

The electrical system 162 may further include a backup battery, such that the memory 190 may be maintained over long periods of being disconnected from the power supply 166. Further, the electrical system 162 may include a large number of sensors or limit switches 122. The illustrated dispenser system 10 includes twenty-eight different holding assemblies 98, but many more are possible. In one embodiment, additional holding assemblies 98 and associated limit switches 122 may be patched into the existing electrical system 162 via an add-on input/output (I/O) board.

FIGS. 19 and 20 show a dispenser system 286 according to another embodiment of the invention designed for larger retail items or cigarette cartons 300. The dispenser system 286 includes a housing 304 that defines trays 308 and partition walls 312. The cigarette cartons 300 rest on the trays 308 when held in the dispenser system 286 and the partition walls 312 maintain the cartons 300 in individual trays 308. Each tray 308 also defines a front flange 314 that extends upward from the tray 308.

Each tray 308 includes an associated sensor in the form of a limit switch 316. Other types of sensors may be used as desired. Each limit switch 316 is associated with a hinged lever 320 that is movable between a first position (indicated by reference A in FIG. 20) and a second position (indicated by reference B in FIG. 20). The limit switch 316 biases the hinged lever 320 toward the first position. In one embodiment, the limit switch 316 includes a spring biases lever (not shown) that provides the bias to the hinged lever 320. In other embodiments, a separate spring or other biasing member may be used, as desired.

The dispenser system 286 includes an electrical system (not shown) similar to the electrical system 162 discussed above and will not be discussed in detail with respect to the dispenser system 286.

Operation of the dispenser system 286 follows very closely the operation of the dispenser system 10. An authorized user loads the cartons 300 into the individual trays 308, forcing the hinged levers 320 to the second position, and pushes the cartons 300 behind the flange 314. The cartons 300 are then maintained in the trays 308 under compression between the hinged lever 320 and the flange 314.

When an employee makes a sale of a carton 300, the employee lifts a front of the carton 300 over the top of the flange 314. The spring bias of the limit switch 316 then pushes the hinged lever 320 and the carton is extended from the tray 308 (indicated by reference C in FIG. 19). A count associated with that tray 308 is then recorded in a memory of the electrical system. At the end of a shift, the authorized user generates a report and compares the number of cartons 300 sold to the number of cartons 300 removed from the dispenser system 286.

All the safety, surveillance, and time stamp data is recorded as described above with respect to dispenser system 10 above. The dispenser systems 10, 286 may be used together to provide a seamless retail environment that is well protected against theft.

The invention provides a simple and easy to use solution to a long standing problem. As cigarette and other high demand retail products continue to rise in price, theft becomes a larger and larger concern for a retail establishment owner or manager. The invention provides a retail dispenser that tracks items removed from the stock, provides information about events during sales hours (e.g., time stamps), provides recorded records (e.g., video recordings) during times of system vulnerability, and allows for a simple and accurate count of items at the end of a shift.

The invention further provides a method of operating a pack dispenser system. The method includes: manually removing a pack from the pack dispenser system; recording a removed item count to a memory in response to removing the pack from the pack dispenser system; selling the pack after manually removing; recording a sale record in response to selling the pack; and comparing the removed item count to the sale record.

The method may also include opening a door and loading a plurality of packs into the pack dispenser system and after opening the door, activating a surveillance system; or recording a time stamp after opening the door; or authenticating a user before opening the door; or a plurality of different types of packs are held in the pack dispenser system, and recording the removed item count includes associating the removed item count with the type of pack removed; or manually removing a second pack from the pack dispenser system and subsequently placing the second pack in a discarded item bin; or recording a discarded item count in response to placing the second pack in the discarded item bin; or comparing the sale record to the removed item count minus the discarded item count; or comparing the sale record to the removed item count minus the number of packs in the discarded item bin; or recording a time stamp when a power supply is disconnected; or recording a time stamp when a power supply is connected; or recording a time stamp when access is provided to the pack; or recording a time stamp when a user attempts and authentication process; or recording a time stamp when a dispenser system time and date are altered; or inhibiting removal of more than a single pack in a single event; or the controller records a time stamp to the memory when the user is authenticated.

The invention further provides a method of selling product packs. The method includes employing a human operator to dispense the packs from a secure system, the system including a housing defining a plurality of columns of packs, the pack at the bottom of each column being supported on a slide carriage of the column that is operable manually by the human operator to slide the bottom pack forward to an opening through which the human operator can remove the bottom pack from the housing, a plurality of sensors that detect when the bottom pack of each column has been removed from the housing, a control unit connected to the sensors that count how many packs have been removed from the housing, and a video surveillance system focused on the housing, the human operator refilling the housing with packs; and the control unit turning on the video surveillance system when the housing is opened.

In some embodiments of the claimed pack dispenser system, the carriage includes a handle graspable by a user for moving the carriage between the first position and the second position; or the carriage slides along a linear path between the first position and the second position and dispenses a bottom pack of a column of packs through an opening in the housing in the second position; or the tamper resistant sensor is a limit switch that is actuated by the carriage; or the housing includes a plurality of holding assemblies, each holding a different pack, and the pack dispenser system also includes a plurality of tamper resistant sensors, one tamper resistant sensor associated with each of the plurality of holding assemblies and operable to actuate when the pack is removed from the holding assembly; or each tamper resistant sensor is in communication with the controller and the controller is operable to record a different removed item count each time the pack is removed and associate the removed item count with the holding assembly the pack was removed from; or each tamper resistant sensor is in communication with the controller via a separate circuit; or the holding assembly includes a lever in communication with the tamper resistant sensor, the lever in selective contact with the pack and operable to actuate the tamper resistant sensor when the pack is removed.

Various features and advantages of the invention are set forth in the following claims.

I claim:

1. A pack dispenser system comprising:
a housing including a holding assembly for holding a pack, the pack being manually removable from the holding assembly;
a tamper resistant sensor associated with the holding assembly and operable to actuate when the pack is removed from the dispenser system, the tamper resistant sensor not being actuatable except by the event of removing the pack; and
a controller associated with the tamper resistant sensor and operable to record a removed item count to a memory each time a pack is removed from the holding assembly.

2. The pack dispenser system of claim 1, wherein the holding assembly includes a carriage supporting the pack, the carriage movable between a first position wherein the pack is inhibited from removal and a second position wherein the pack may be removed.

3. The pack dispenser system of claim 2, wherein the tamper resistant sensor is actuated by movement of the carriage between the first position and the second position.

4. The pack dispenser system of claim 2, wherein the holding assembly holds a plurality of packs and the carriage includes a block that inhibits a second pack held by the holding assembly from removal.

5. The pack dispenser system of claim 2, wherein the carriage includes a guard member that inhibits the pack from removal unless the carriage is in the second position.

6. The pack dispenser system of claim 5, wherein the guard member is movable between a first position inhibiting removal of the pack when the carriage is in the first position, and a second position allowing removal of the pack when the carriage is in the second position, and
wherein when moving from the second position to the first position of the carriage, the guard member moves back into the first position inhibiting removal of the pack before the sensor is changed in state by movement of the carriage.

7. The pack dispenser system of claim 1, wherein the housing further includes a door movable between an open position allowing access to the pack and a closed position inhibiting access to the pack, the controller monitoring when the door is in the open position.

8. The pack dispenser system of claim 7, wherein the controller records a time stamp to the memory when the door is moved out of the closed position.

9. The pack dispenser system of claim 7, wherein the controller activates a surveillance system when the door is moved out of the closed position.

10. The pack dispenser system of claim 7, wherein the controller activates an alarm when the door is moved out of the closed position.

11. The pack dispenser system of claim 7, wherein the controller records a time stamp to the memory when the door is moved to the closed position.

12. The pack dispenser system of claim 1, further comprising a discarded pack bin and a discarded item sensor associated with the discarded pack bin, the discarded item sensor in communication with the controller and the controller operable to record a discarded item count to the memory each time a pack is placed in the discarded pack bin.

13. The pack dispenser system of claim 1, wherein the holding assembly holds a plurality of identical packs and is arranged such that only one pack may be removed in a single event, the tamper resistant sensor being actuated by each event.

14. The pack dispenser system of claim 1, wherein the controller records a time stamp to the memory if the dispenser system loses power.

15. The pack dispenser system of claim 1, wherein the controller records a time stamp to the memory if the dispenser system regains power after losing power.

16. The pack dispenser system of claim 1, wherein access to the holding assembly is granted only after a user is authenticated.

17. The pack dispenser system of claim 16, wherein the user is authorized by entering an authorized key code into a keypad associated with the controller.

18. The pack dispenser system of claim 16, wherein the user is authorized by inserting an authorized USB device into a USB port associated with the controller.

19. The pack dispenser system of claim 1, wherein the controller is operable to output a report including all the counts recorded.

20. The pack dispenser system of claim 1, wherein the controller records a time stamp to the memory when an event occurs, wherein the time stamp is synchronized with a surveillance system.
